(19) United States
(12) Patent Application Publication
(10) Pub. No.: US 2025/0013507 A1
(43) Pub. Date: Jan. 9, 2025

(54) TECHNOLOGIES FOR COMPUTER POWER MANAGEMENT

(71) Applicant: Intel Corporation, Santa Clara, CA (US)

(72) Inventors: Chris M. MacNamara, Ballyclough (IE); John J. Browne, Limerick (IE); Przemyslaw J. Perycz, Sopot (PL); Pawel S. Zak, Gdansk (PL); Reshma Pattan, Tuam (IE)

(73) Assignee: Intel Corporation, Santa Clara, CA (US)

(21) Appl. No.: 18/891,976

(22) Filed: Sep. 20, 2024

Related U.S. Application Data
(60) Provisional application No. 63/564,742, filed on Mar. 13, 2024.

(51) Int. Cl. G06F 9/50; G06F 1/26; G06F 9/48

(52) U.S. Cl. CPC G06F 9/5094; G06F 1/26; G06F 9/4893

(57) ABSTRACT

Techniques for computer power management are disclosed. In one embodiment, a data center includes several compute nodes and a power management node. Power telemetry data is gathered at each of the compute nodes and sent to the power management node. The power management node analyzes the telemetry data, such as by applying filtering to identify certain metrics. The power management node may use rules to analyze the telemetry data and determine whether power management actions should be performed. The power management node may instruct the compute node to, e.g., change a power state of a processor or processor core. In some embodiments, cores may be managed by an orchestrator, and the orchestrator may identify cores to be placed in high-power and low-power states, as appropriate.

### CROSS-REFERENCE TO RELATED APPLICATIONS

This application claims the benefit under 35 U.S.C. § 119(e) to U.S. Provisional Patent Application Ser. No. 63/564,742, filed Mar. 13, 2024, and entitled “TECHNOLOGIES FOR COMPUTER POWER MANAGEMENT,” which is incorporated by reference herein in its entirety.

### BACKGROUND

Severs in data centers can use enormous amounts of power, amounting to operating costs in the millions of dollars a year for many data centers. In many cases, processor cores are in a high-power state but not performing any useful computation. Reducing the power usage or idle processors can significantly reduce the power usage of a data center.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of several compute nodes and an orchestrator node connected by a network.

FIG. 2 is a simplified block diagram of at least one embodiment of a compute node of FIG. 1.

FIG. 3 is a simplified block diagram of at least one embodiment of an environment that may be established by a compute node of FIG. 1.

FIG. 4 is a simplified block diagram of at least one embodiment of an environment that may be established by an orchestrator node of FIG. 1.

FIG. 5 is a simplified block diagram of at least one embodiment of resource allocation that may be implemented by a compute node of FIG. 1.

FIG. 6 is a simplified flow diagram of at least one embodiment of a method for power management that may be executed by one or more nodes of FIG. 1.

FIGS. 7-9 are a simplified flow diagram of at least one embodiment of a method for power management that may be executed by one or more nodes of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

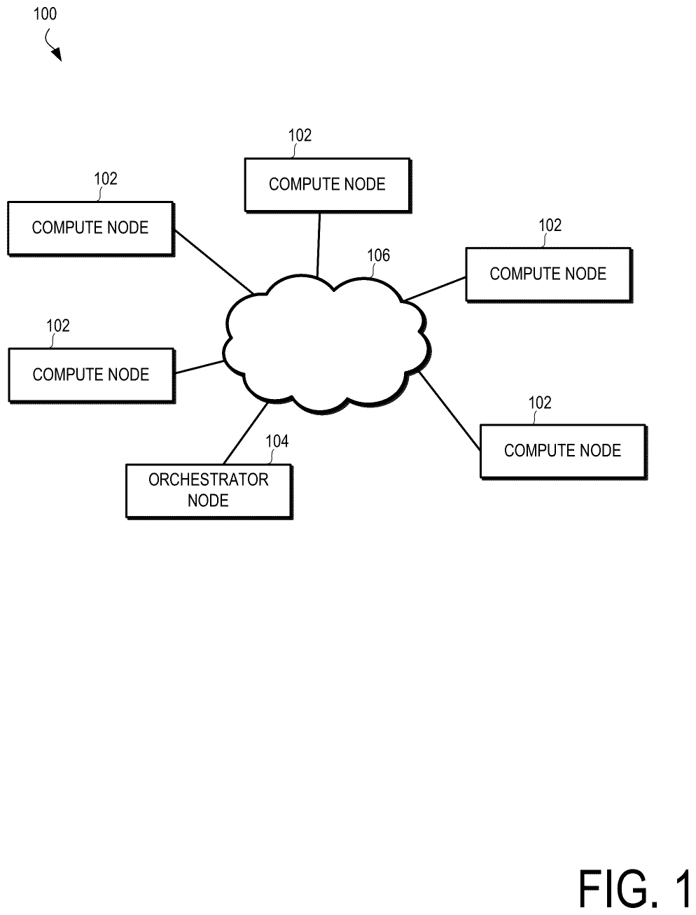

Referring now to FIG. 1, an illustrative system 100 includes one or more compute nodes 102 and one or more orchestrator nodes 104 connected by a network 106. The compute nodes 102 may perform various computing tasks, and the orchestrator node 104 is configured to monitor and manage the power usage of the compute nodes 102, as described in more detail below.

The techniques disclosed herein address the problem of how to detect zombie and stranded or idled cores/CPUs across single nodes up to typical large-scale data center environments with thousands of processors. The techniques address how to reduce the power for those cores/processors that are zombies or stranded/idle.

In one embodiment, the approach described herein solves four power consumption problems. First, it allows power saving in powered-up servers that may be “staged” as part of a pre-production rollout of services while consuming power to be automatically detected and placed in a reduced power state pre-deployment of services. Second, it allows power saving in servers running workloads that have unused cores by automatically detecting the unused cores and placing the unused cores in a reduced power-saving state while other cores are running workloads. Third, it allows power saving in cores that are rarely used. Fourth, it allows power saving in cores that are unallocated to a workload or service, including when managed by an orchestrator.

The power management technology techniques disclosed herein achieve an estimated savings benefit of up to about 65% of currently consumed core power for (1) a core that is classified as idle, (2) that runs 100% in the active state, also known as core C0, and (3) comparing active (C0) to deep sleep, where a deep sleep state in the processor may be, e.g., when an Intel® Xeon® Core is in processor state C6. Different processors from different manufacturers may have different processor states. Some features of the techniques disclosed herein include rules and innovative measurement of power core power. The techniques can determine power consumption and automatically reduce power used by those processors and cores by putting them into lower power states and, in some embodiments, marking these cores as “reusable” to a scheduler, such as a Kubernetes (K8) scheduler.

The techniques disclosed herein allow for improvements over other techniques. Other techniques may require the user and/or operations team to know in advance which cores are used and which cores are not used and manually power down cores. Such approaches cannot easily scale to a large number of processors. Other techniques may not allow for a per-core power estimation to attribute power to a workload.

In some cases, other techniques may use out-of-band power measurement to measure per processor power, with but without visibility of per core power. However, such an approach has limitations. Out-of-band measurements may not have the fine-grained detail that may be available from in-band telemetry insight that requires application and OS-level utilization visibility, including per core utilization, per application utilization, etc. For example, an application may be present but waiting for an event, showing low usage of a processor. An out-of-band solution may guess there is nothing running with such low utilization and place the processor in a low-power mode, while the application may require a high-power mode. Additionally, out-of-band solutions may not have core-level visibility and may, therefore, be unable to put individual cores into deep sleep states. For example, an out-of-band solution may be limited to power policies that operate at the processor level, such as power capping and RAPL, which keep the processor within a fixed power budget but do not allow greater power savings by identifying per-core opportunities. Additionally, out-of-band solutions typically have low latency, with refresh rates of about 15 minutes, compared with in-band communications that may have a latency of microseconds to milliseconds. For example, if a workload was scheduled to a node in a low-power node, the workload could be hindered by a lower-power mode until the out-of-band automation responded, causing operational issues.

The approach in some embodiments stages at a high level by scanning a fleet of servers, checking each server CPU and/or core for activity, using utilization and hooks to orchestration to determine the allocation, and changing the power state of the cores that do not need to be in an active power state, which will result in power saving. Some embodiments of this approach can be integrated into solutions using closed-loop power management. The techniques disclosed allow customers to save power, reduce operational expenditure, and reduce carbon emissions to meet regulatory and customer requirements.

In some embodiments, CPU cores may be managed by an orchestrator, such as software running on an orchestrator node 104 and/or one or more compute nodes 102. Previous methods may rely on scripting separate from the orchestrator to find unallocated cores and change power states. The present disclosure creates a new power management life-cycle flow that can be completely controlled by the orchestrator and does not require other automation systems to intervene and interact with the CPU cores for power management life cycle management.

The techniques disclosed herein allow for a new method in an orchestrator to trigger various resources (such as CPU cores, CPU uncore, accelerators, GPUs, and other platform components) into low-power states in various circumstances. For example, the orchestrator may place a CPU into a low-power state when less than a user-defined number of pods are deployed (such as less than 0-5 pods deployed), when a pod matching a specified list of pods is not deployed, when individual cores are managed by the orchestrator but do not have any pods allocated to them, etc.

An orchestrator may have various functions in various embodiments. Several possible examples are listed below, and an orchestrator may perform any suitable function or combination of functions described below. For example, an orchestrator may dynamically allocate processors or cores across different physical or virtual nodes in a data center, ensuring efficient use of resources across multiple systems. An orchestrator may be remote from the nodes it is controlling or be distributed between both the nodes it is managing and other external nodes, allowing for decentralized decision-making and scalability. An orchestrator may deploy or initialize new virtual environments or microservices when it detects idle resources, automatically scaling workloads based on demand. An orchestrator may monitor the performance of applications and services running across nodes and automatically scale them up or down by provisioning additional containers or virtual machines based on load. An orchestrator may manage network traffic by rerouting or balancing loads between different nodes, ensuring high availability and optimal use of network resources. An orchestrator may schedule distributed tasks across multiple servers in the data center, orchestrating when and where workloads are processed based on current resource usage and workload requirements. An orchestrator may detect node or service failures and automatically trigger failover mechanisms or initiate the migration of services to healthy nodes, ensuring continued availability.

A significant opportunity exists for power optimizing idle cores and resources. For example, a large data center may have millions of idle cores that are not power-optimized. Identifying and configuring these cores into low-power modes could save millions of dollars of annual operating expenses in electricity costs, but such an effort may require significant manual effort by human intervention. The techniques disclosed herein allow for a controller of an orchestrator to implement automatic identification and power optimization of idle resources, which can be achieved when the orchestrator is managing the cores.

When using orchestrators such as Kubernetes®, a data center may have underutilized CPUs. It may be desirable to have a solution to lower power, reduce electricity operating expenses, and improve the performance per watt of the CPUs without impacting the service level agreement (SLA) of workloads and servers that are managed by the orchestrator. A solution that is transparent and/or invisible to the operations teams can reduce issues and operational burdens. When an orchestrator is deployed and manages a set of cores, the orchestrator owns the allocation of the cores to workloads. The techniques described herein can provide a power-saving approach for cores that are managed by an orchestrator. The techniques can include interfaces to orchestrator CPU manager APIs to find the allocated cores, hooks to the orchestrator watcher/informer to detect incoming and outgoing workloads/pods, reading the specification of incoming pods to find their name and deciding on the priority of the named pods, counting pods to determine if any apps are running and the logic to apply power optimization methods, and the like.

In an illustrative embodiment, the compute nodes 102, the orchestrator node 104, and the network 106 are within a datacenter. For example, the compute nodes 102 and/or orchestrator nodes 104 may be sleds in a rack of a datacenter, and the network 106 may be embodied as cables, routers, switches, etc., that connect racks in a datacenter. The system 100 may include any suitable number of compute nodes 102, such as dozens to millions or more compute nodes 102 for a large data center. The system 100 may include any suitable number of orchestrator nodes 104, such as one to hundreds. In some embodiments, the function of the orchestrator nodes 104 may be distributed among several compute devices, including several compute nodes 102, and other orchestration function may be performed on the orchestrator nodes 104. The system 100 may include any suitable data center, such as an edge network, a cloud data center, an edge data center, a micro data center, a multi-access edge computing (MEC) environment, etc. Additionally or alternatively, in some embodiments, one or both of the compute nodes 102 and/or the orchestrator nodes 104 may be outside of a data center, such as compute nodes 102 and/or orchestrator nodes 104 that form part of or connect to an edge network, a cellular network, a home network, a business network, a satellite network, etc.

In the illustrative embodiment, the compute nodes 102 and/or the orchestrator nodes 104 may be any suitable device that can communicate over a network 106, such as a server computer, a rack computer, a desktop computer, a laptop, a mobile device, a cell phone, a router, a switch, etc.

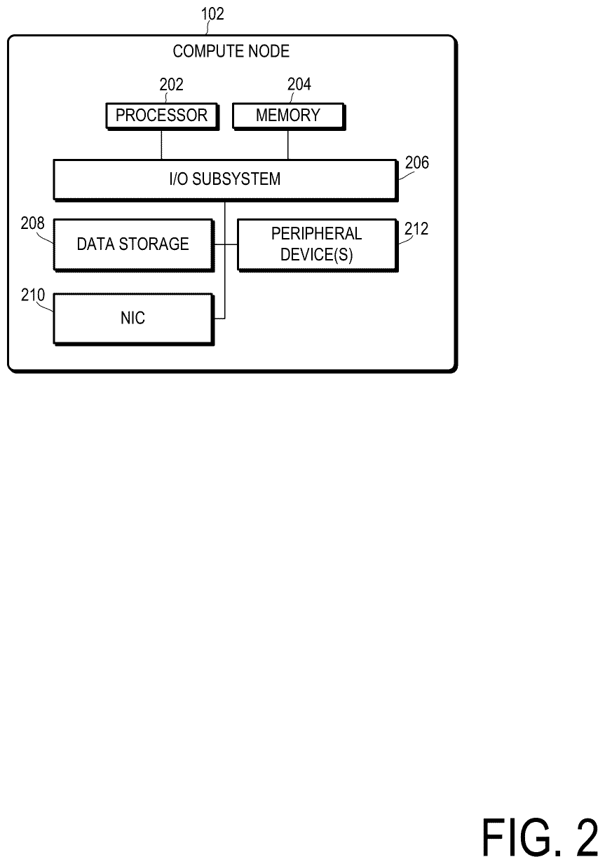

Referring now to FIG. 2, a simplified block diagram of a compute node 102 is shown. The compute node 102 may be embodied as any type of compute device. For example, the compute node 102 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, a distributed computing system, and/or any other computing device. The illustrative compute node 102 includes a processor 202, a memory 204, an input/output (I/O) subsystem 206, data storage 208, a network interface controller (NIC) 210, and one or more optional peripheral devices 212. In some embodiments, one or more of the illustrative components of the compute node 102 may be incorporated in, or otherwise form a portion of, another component. For example, the memory 204, or portions thereof, may be incorporated in the processor 202 in some embodiments.

In some embodiments, the compute node 102 may be located in a data center with other compute nodes 102, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves), a micro data center, etc.

The processor 202 may be embodied as any type of processor capable of performing the functions described herein. For example, the processor 202 may be embodied as a single or multi-core processor(s), a single or multi-socket processor, a digital signal processor, a graphics processor, an edge processor, a neural network compute engine, an image processor, a microcontroller, an infrastructure processing unit (IPU), a data processing unit (DPU), an xPU, or other processor or processing/controlling circuit. The processor 202 may include any suitable number of cores, such as any number from 1-1,024. In some embodiments, the compute node 102 may include any combination of two or more of the processors 202 described above.

The memory 204 may be embodied as any type of volatile or non-volatile memory or data storage capable of performing the functions described herein. In operation, the memory 204 may store various data and software used during operation of the compute node 102, such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the compute node 102. For example, the I/O subsystem 206 may be embodied as, or otherwise include, memory controller hubs, input/output control hubs, firmware devices, communication links (e.g., point-to-point links, bus links, wires, cables, light guides, printed circuit board traces, etc.) and/or other components and subsystems to facilitate the input/output operations. The I/O subsystem 206 may connect various internal and external components of the compute node 102 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 206 may form a portion of a system-on-a-chip (SoC) and be incorporated, along with the processor 202, the memory 204, the NIC 210, and other components of the compute node 102 on a single integrated circuit chip.

The data storage 208 may be embodied as any type of device or devices configured for the short-term or long-term storage of data. For example, the data storage 208 may include any one or more memory devices and circuits, memory cards, hard disk drives, solid-state drives, or other data storage devices.

The NIC 210 may be embodied as any type of interface capable of interfacing the compute node 102 with other compute devices, such as over one or more wired or wireless connections. In some embodiments, the NIC 210 may be capable of interfacing with any appropriate cable type, such as an electrical cable or an optical cable. The NIC 210 may be configured to use any one or more communication technology and associated protocols (e.g., Ethernet, Bluetooth®, Wi-Fi®, WiMAX, near field communication (NFC), 4G, 5G, etc.). The NIC 210 may be located on silicon separate from the processor 202, or the NIC 210 may be included in a multi-chip package with the processor 202, or even on the same die as the processor 202. The NIC 210 may be embodied as one or more add-in-boards, daughtercards, network interface cards, controller chips, chipsets, specialized components such as a field-programmable gate array (FPGA) or application-specific integrated circuit (ASIC), or other devices that may be used by the compute node 102 to connect with another compute device. In some embodiments, NIC 210 may be embodied as part of a system-on-a-chip (SoC) that includes one or more processors, or included on a multichip package that also contains one or more processors. In some embodiments, the NIC 210 may include a network accelerator complex (NAC), which may include a local processor, local memory, and/or other circuitry on the NIC 210. In such embodiments, the NAC may be capable of performing one or more of the functions of the processor 202 described herein. Additionally or alternatively, in such embodiments, the NAC of the NIC 210 may be integrated into one or more components of the compute node 102 at the board level, socket level, chip level, and/or other levels.

In some embodiments, the compute node 102 may include other or additional components, such as those commonly found in a compute device. For example, the compute node 102 may also have a graphics processing unit (GPU), peripheral devices 212, such as a keyboard, a mouse, a speaker, a microphone, a display, a camera, a battery, an external storage device, etc.

The orchestrator node 104 may include hardware similar to or the same as the compute node 102, which will not be repeated in the interest of clarity.

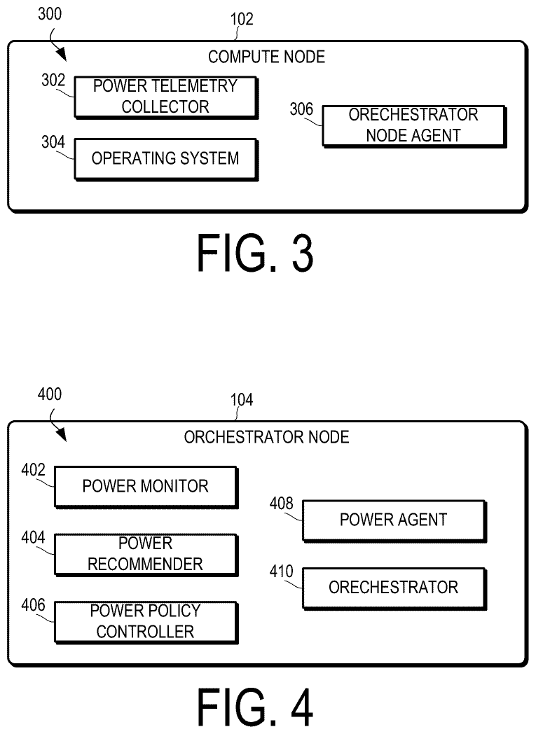

Referring now to FIG. 3, in an illustrative embodiment, the compute node 102 establishes an environment 300 during operation. The illustrative environment 300 includes a power telemetry collector 302, operating system 304, and orchestrator node agent 306. The various modules of the environment 300 may be embodied as hardware, software, firmware, or a combination thereof. For example, the various modules, logic, and other components of the environment 300 may form a portion of, or otherwise be established by, the processor 202 or other hardware components of the compute node 102 such as the memory 204, the data storage 208, etc. As such, in some embodiments, one or more of the modules of the environment 300 may be embodied as circuitry or collection of electrical devices (e.g., power telemetry collector circuitry, etc.). In some embodiments, some or all of the modules of the environment 300 may be embodied as, e.g., a field programmable gate array (FPGA), an application-specific integrated circuit (ASIC), an accelerator device, and/or the like. It should be appreciated that, in some embodiments, one or more of the circuits (e.g., the power telemetry collector circuitry, etc.) may form a portion of one or more of the processor 202, the memory 204, the I/O subsystem 206, the data storage 208, and/or other components of the compute node 102. For example, in some embodiments, some or all of the modules may be embodied as the processor 202 as well as the memory 204 and/or data storage 208 storing instructions to be executed by the processor 202. Additionally, in some embodiments, one or more of the illustrative modules may form a portion of another module and/or one or more of the illustrative modules may be independent of one another. Further, in some embodiments, one or more of the modules of the environment 300 may be embodied as virtualized hardware components or emulated architecture, which may be established and maintained by the processor 202 or other components of the compute node 102. It should be appreciated that some of the functionality of one or more of the modules of the environment 300 may require a hardware implementation, in which case embodiments of modules that implement such functionality will be embodied at least partially as hardware.

The power telemetry collector 302, which may be embodied as hardware, firmware, software, virtualized hardware, emulated architecture, and/or a combination thereof as discussed above, is configured to collect power telemetry related to one or more processors 202, processor cores, or other components of the compute node 102. The power telemetry collector 302 may collect, e.g., processor frequency (e.g., current operational frequency of CPU core and/or CPU core busy frequency measured as frequency adjusted to CPU core busy cycles), processor temperature, state residency data such as cpu_c1_state_residency and/or cpu_c6_state_residency data (e.g., percentage of time CPU core spent in C1 core residency state and/or percentage of time CPU core spent in C6 core residency state), processor busy cycles (e.g., CPU core busy cycles as a ratio of cycles spent in C0 state residency to all cycles executed by CPU core), etc., for each processor 202 and/or processor core of the compute node 102. In some embodiments, telemetry may be collected on a graphics processing unit (GPU) and/or GPU cores, in addition to or alternatively to collecting telemetry on a CPU. In general, the telemetry, analysis, control, etc., being done on a CPU and cores of a CPU as described herein can be performed in a similar manner on GPUs and/or cores of a CPU. Additionally or alternatively, in some embodiments, the power telemetry collector 302 may collect per node data, such as the maximum thermal design power available for the processor package, current power consumption of the processor package, and current power consumption of the processor package DRAM subsystem. In an illustrative embodiment, the power telemetry collector 302 sends the telemetry data to the orchestrator node 104 over the network 106. Additionally or alternatively, in some embodiments, some or all of the filtering and/or analysis may be performed by the power telemetry collector 302 or other module of the compute node 102, which reduces bandwidth requirements for the power telemetry data.

The operating system 304, which may be embodied as hardware, firmware, software, virtualized hardware, emulated architecture, and/or a combination thereof as discussed above, is configured to perform general system tasks, such as a DHCP client, SSHD, etc. In some embodiments, the operating system controls the scheduling of jobs on the various processor cores. In other embodiments, a component of the orchestrator (e.g., the orchestrator node agent 306) may assign jobs to dedicated static cores of the processor.

The orchestrator node agent 306, which may be embodied as hardware, firmware, software, virtualized hardware, emulated architecture, and/or a combination thereof as discussed above, is configured to interface with the components of the orchestrator node 104, such as the orchestrator 410, and to control workloads deployed to the compute node 102. In an illustrative embodiment, the orchestrator node agent 306 determines a CPU manager core allocation policy. The policy may be the same for each compute node 102, or the policy may be different for the different compute nodes. In an illustrative embodiment, there are two possible configurations corresponding to two possible settings for a cpuManagePolicy parameter. In one configuration, the cpuManagerPolicy may be set to “static,” and the orchestrator software on the compute node 102 allocates individual cores of the processor 202 of the compute node 102 to pods with exclusivity. If the cpuManagerPolicy is set to “none,” the cores 502 are allocated using a general scheduler controlled by the operating system with no specific allocation of cores to pods. Operation with a “static” CPU manager policy will be described first.

Upon initialization, the orchestrator node agent 306 may place the workload cores of the compute node 102, which are initially unallocated, into a low-power mode. The cores may be placed into a low-power mode in any suitable manner. For example, clock gating may be used, power gating may be used, dynamic voltage and frequency scaling (DVFS) may be used, etc. In some embodiments, sleep modes may be used, in which cores can enter progressively deeper levels of power saving. For example, in one embodiment, a core may have sleep modes C0 (an active state, in which the core is fully operational), C1 (a halt state, in which the core is not executing instructions but can quickly resume activity), C2 (a stop-clock state, in which the clock to the core is stopped, saving more power but taking longer to resume activity), C3 (a sleep state, in which the core is put to sleep, with its cache memory retained but most other functions powered down), and C6 (a deep power down state, in which the core's state is saved and the power is cut off almost entirely, which saves the most power but requires the longest time to wake up). In some embodiments, different and/or additional states may be used, such as a C0, C1, C1E, C2, C3, and C6 states, and/or RUN, IDLE, STANDBY/SLEEP, RETENTION, and OFF states. When a core is placed into a low-power state, the core may be placed into any suitable low-power state, such as C1, C2, C3, C6, etc. In an illustrative embodiment, the orchestrator node agent 306 initially places the unallocated cores into a C6 state.

In operation, the orchestrator node agent 306 monitors for incoming and outgoing workloads/pods deployed to and removed from the compute node 102. The orchestrator node agent 306 can read the specification of incoming pods, including the name of the incoming pods, decide on the priority of pods, such as deciding on the priority of pods based on the name of the pod, count pods to determine if any workloads are running, implement logic to apply power optimization methods, and/or the like.

Upon detecting a change in workload, the orchestrator node agent 306 checks if any workload cores need to be restored to a high-power mode. For example, if a pod was assigned to a core in a low-power mode, the orchestrator node agent 306 may place that core into a higher-power mode, such as an operational or full-power mode (e.g., in state C0). Additionally or alternatively, if a pod is removed from a core, the orchestrator node agent 306 may place that core into a low-power mode.

In some embodiments, the orchestrator node agent 306 may query an unallocated cores list to check for unallocated cores. The orchestrator node agent 306 may perform the query after a change in workload is detected and/or may perform the query periodically, continuously, or continually. In an illustrative embodiment, a query to find the allocated cores is only achievable for static kubelet configurations. The unallocated can be determined from the list of allocated cores. In some embodiments, to perform a query, a new controller is deployed as a pod. The controller may be embodied as, include, or be included in the orchestrator node agent 306. The controller can interact with an orchestrator such as Kubernetes® and can determine which cores are allocated and unallocated. The controller may run a query via the CPU manage state file to return the allocated cores on a given CPU via CPU manager reading and by parsing a file. In an illustrative embodiment, the file may be located at /var/lib/kubelet/cpu_manager_state. This file can be used to query the allocated cores and determine the unallocated cores. The orchestrator node agent 306 can place allocated cores in a high-power mode, such as C0, and place unallocated cores in a low-power mode, such as C6.

In some embodiments, the orchestrator node agent 306 may operate with a dynamic or non-static CPU manager policy. The orchestrator node agent 306 can read the specification of incoming pods, including the name of the incoming pods, decide on the priority of pods, such as deciding on the priority of pods based on the name of the pod, count pods to determine if any workloads are running, implement logic to apply power optimization methods, and/or the like. The orchestrator node agent 306 may be configured to control how cores will be placed into low- and high-power modes. For example, a user-defined parameter may be set for a threshold number of pods deployed to the processor, such as 0-5 pods, under which some or all of the cores of a processor may be placed in a low-power state. Additionally or alternatively, a user may specify a list of pod names, and when a pod matching that list is deployed, certain actions may be taken, such as placing some or all of the cores in a low- or high-power state. The orchestrator node agent 306 may access the parameter for the threshold number of pods and one or more such lists of pod names.

In operation, the orchestrator node agent 306 monitors for a change in the workload. Upon such a change, the orchestrator node agent 306 may check if the number of deployed pods is above a minimum threshold, such as the user-defined threshold referred to above. If the deployed workloads are not above a minimum threshold, the orchestrator node agent 306 may place some or all of the cores in a low-power mode. If the deployed workloads are above a minimum threshold, if the workload is specified for a high-power core, such as by having a name that is on a list provided by a user or by having a parameter associated with it indicating a high-power core, the orchestrator node agent 306 may place some or all of the cores of the processor 202 in a high-power mode. If the workload is not specified for a high-power core, the orchestrator node agent 306 may place some or all of the cores in a low-power mode.

Referring now to FIG. 4, in an illustrative embodiment, the orchestrator node 104 establishes an environment 400 during operation. The illustrative environment 400 includes a power monitor 402, a power recommender 404, a power policy controller 406, a power agent 408, and an orchestrator 410. The various modules of the environment 400 may be embodied as hardware, software, firmware, or a combination thereof. For example, the various modules, logic, and other components of the environment 400 may form a portion of, or otherwise be established by, the processor 202 or other hardware components of the orchestrator node 104 such as the memory 204, the data storage 208, etc. As such, in some embodiments, one or more of the modules of the environment 400 may be embodied as circuitry or collection of electrical devices (e.g., power monitor circuitry, power recommender circuitry, power policy controller circuitry, etc.). In some embodiments, some or all of the modules of the environment 400 may be embodied as, e.g., a field programmable gate array (FPGA), an application-specific integrated circuit (ASIC), an accelerator device, and/or the like. It should be appreciated that, in some embodiments, one or more of the circuits (e.g., the power monitor circuitry, the power recommender circuitry, the power policy controller circuitry, etc.) may form a portion of one or more of the processor 202, the memory 204, the I/O subsystem 206, the data storage 208, and/or other components of the orchestrator node 104. For example, in some embodiments, some or all of the modules may be embodied as the processor 202 as well as the memory 204 and/or data storage 208 storing instructions to be executed by the processor 202. Additionally, in some embodiments, one or more of the illustrative modules may form a portion of another module and/or one or more of the illustrative modules may be independent of one another. Further, in some embodiments, one or more of the modules of the environment 400 may be embodied as virtualized hardware components or emulated architecture, which may be established and maintained by the processor 202 or other components of the compute node 102. It should be appreciated that some of the functionality of one or more of the modules of the environment 400 may require a hardware implementation, in which case embodiments of modules that implement such functionality will be embodied at least partially as hardware.

The power monitor 402, which may be embodied as hardware, firmware, software, virtualized hardware, emulated architecture, and/or a combination thereof as discussed above, is configured to monitor power telemetry received from the compute node 102. The power monitor 402 may filter power telemetry data to key metrics, which may be pre-defined. The use of key metrics can be important for scaling to large deployments. The power monitor 402 may filter for input based on the use case being implemented in the rule's entity.

The power recommender 404, which may be embodied as hardware, firmware, software, virtualized hardware, emulated architecture, and/or a combination thereof, as discussed above, is configured to analyze the power data. The power recommender 404 may use rules to assess clusters/nodes/processors/processor cores as idle or unallocated. The power recommender 404 can use the monitored telemetry to identify isolated processors and/or cores that are not utilized as stranded processors and/or cores, as well as to identify non-isolated processors and/or cores that are rarely utilized as zombie processors and/or cores. The power recommender 404 may use a recommendation function to estimate the power savings that can be achieved on these processors and cores by putting them into lower power states. The power recommender 404 may use an interface to a scheduler such as Kubernetes to query unallocated physical cores and, in some embodiments, mark these cores as low-power to the scheduler. The power recommender 404 may recommend a power policy to be applied to the platform.

The power recommender 404 may use recommendation system rules to identify the idle status of the core. The rules to determine power saving opportunity (which may be referred to as recommendation engine and controller rules) may, in some embodiments, include some or all of the following. In one embodiment, a core/CPU is considered busy (polling core) if, during a 24-hour time window, core/CPU average utilization over time is over a threshold amount, such as 90%-99% (that is, the core constantly doing a lot of work), and CPU maximum utilization over time is at least a threshold amount, such as 95%-100% (that is, the core/CPU peaks to full utilization). In another embodiment, a core/CPU is considered idle (and therefore a candidate for power saving) if, during a 24-hour time window, the CPU/core average utilization over time is less than a threshold amount, such as 1%-10% (that is, it is idle most of the time, without significant load), and if CPU/core maximum utilization over time is less than a threshold amount, such as 2%-15% (that is, it is not used periodically/by schedule (e.g., via cron) to do any substantial work). Additionally or alternatively, in another embodiment, a core/CPU is considered an ordinary worker if neither of the two previous rules apply.

The power recommender 404 accepts as an input the per-core power in order to recommend the savings possible prior to taking a decision on making a change. To determine the per-core power, various approaches may be used. The approaches may vary depending on the type of processor being used. The per-core watts estimate described below may be used as a basis for savings calculations. The approach described below is merely one possible embodiment, and other embodiments are envisioned as well. In general, any suitable approach may be used to determine a per-core amount of power based on factors such as core frequency, total processor 202 power, and parameters estimating the amount of power used by the cores and the amount of fixed power used by each core.

In one embodiment, a certain fraction of the running average power limit (RAPL)-based package power is assumed to be consumed by cores of the processor 202. For example, the fraction may be 60%, in one embodiment. In that case, a 10-core processor 202 that consumes 100 Watts based on the RAPL, 60 Watts is assumed to be consumed by the cores of the processor 202. In other embodiments, it may be 40%-80% of the RAPL that is assumed to be consumed by cores of the processor 202. A fraction of the amount of the power assigned to the cores is then assigned evenly to the cores. That fraction may be, e.g., 30%-70%. In one embodiment, that fraction is 50%. For example, if 60 Watts is assigned to the 10 cores of a processor 202, then half of that amount (that is, 30 Watts) may be assigned evenly to the 10 cores, or 3 Watts per core. The remaining fraction of the amount of the power assigned to the cores is then distributed among the cores proportionally to the frequency that each core is operating at. For example, if 8 of the 10 cores are operating at 1 GHz and 2 of the 10 cores are operating at 2 GHz, the 1 GHz cores will each be assigned a consumption of 30 Watts*(1 GHz/core/(8 cores*1 GHz/core+2 cores*2 GHz/core))=2.5 Watts/core of frequency-based power consumption. The remaining 2 of the 10 cores operating at 2 GHz will each be assigned a consumption of 30 Watts*(2 GHz/core/(8 cores*1 GHz/core+2 cores*2 GHz/core))=5 Watts/core of frequency-based power consumption.

The power policy controller 406, which may be embodied as hardware, firmware, software, virtualized hardware, emulated architecture, and/or a combination thereof as discussed above, is configured to implement automation rules and/or implement customer-defined rules. For example, in one embodiment, the power policy controller 406 may, on day 0, with use case of power reduction for server pre-orchestration deployment where a server is stood up and not in service, the action may be power profile provisioning/configuration, e.g., set a low-power mode. In another example, in one embodiment, the power policy controller 406 may, on day 1, with use case of power reduction for server post orchestration deployment, wherein the server is stood up, the platform in service, and no workload running, the action may be to idle resource identification and power reduction, with a local or remote decision possible.

The power agent 408, which may be embodied as hardware, firmware, software, virtualized hardware, emulated architecture, and/or a combination thereof as discussed above, is configured to implement a state change for the compute node 102, such as by sending an instruction from the orchestrator node 104 to the compute node 102. The power agent 408 may apply the power policy recommendations. The power agent 408 may use profiles to implement power control using, e.g., Power Management Technology including P states, C states, and/or Uncore Scaling. In some embodiments, the power agent 408 may implement a programmable API to implement power control actions.

The orchestrator 410, which may be embodied as hardware, firmware, software, virtualized hardware, emulated architecture, and/or a combination thereof as discussed above, is configured to manage the compute nodes 102 and workloads assigned to the compute nodes 102. In an illustrative embodiment, the orchestrator 410 may be embodied as a kube API server.

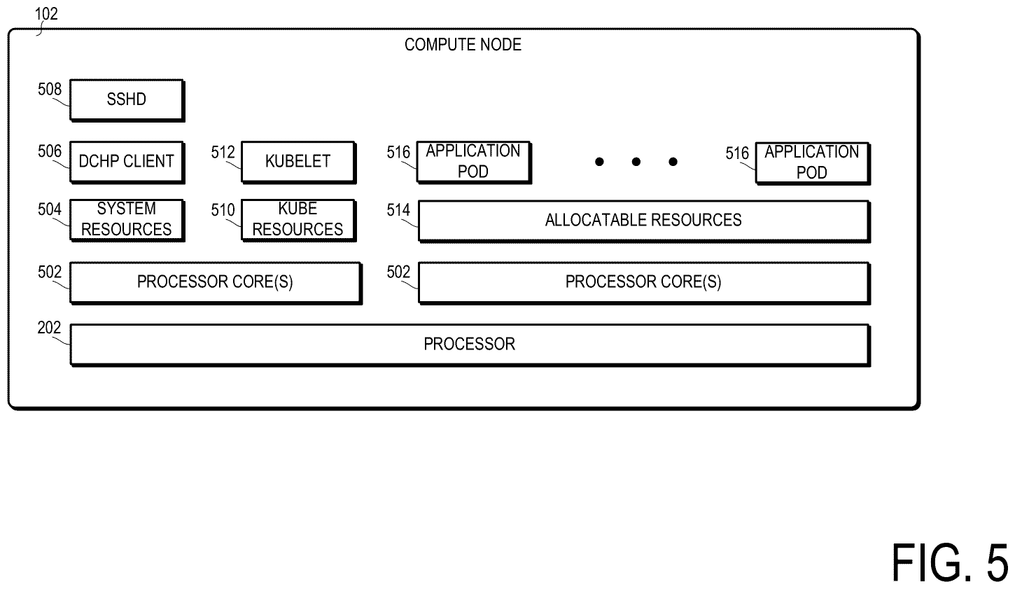

Referring now to FIG. 5, a simplified block diagram of one embodiment of resource allocation that may be implemented by a compute node of FIG. 1 is shown. The processor 202 can have multiple processor cores 502, such as 2-112 cores. Some cores 502 may be reserved for system resources 504, such as a DHCP client 506 and SSHD 508, and, in some embodiments, some cores 502 may be reserved for Kube resources 510, such as one or more kubelets 512. In other embodiments in which other orchestration software is used, the resources may be assigned in a different manner. There is a remaining set of cores 502 that make up allocatable resources 514, which application pods 516 may be allocated to use. These pods 516 may be deployed by the orchestrator node 104 to the compute node 102, and the kubelet 512 can allocate the pods 516 to the cores 502. In an illustrative embodiment, the kubelet 512 may be configured with the cpuManagerPolicy to allocate cores on the compute node 102 in one of two ways. If the kublet 512 cpuManagerPolicy is set to “static,” the kubelet 512 allocates individual cores to pods with exclusivity. If the kublet 512 cpuManagerPolicy is set to “none,” the cores 502 are allocated using a general scheduler controlled by the operating system with no specific allocation of cores to pods.

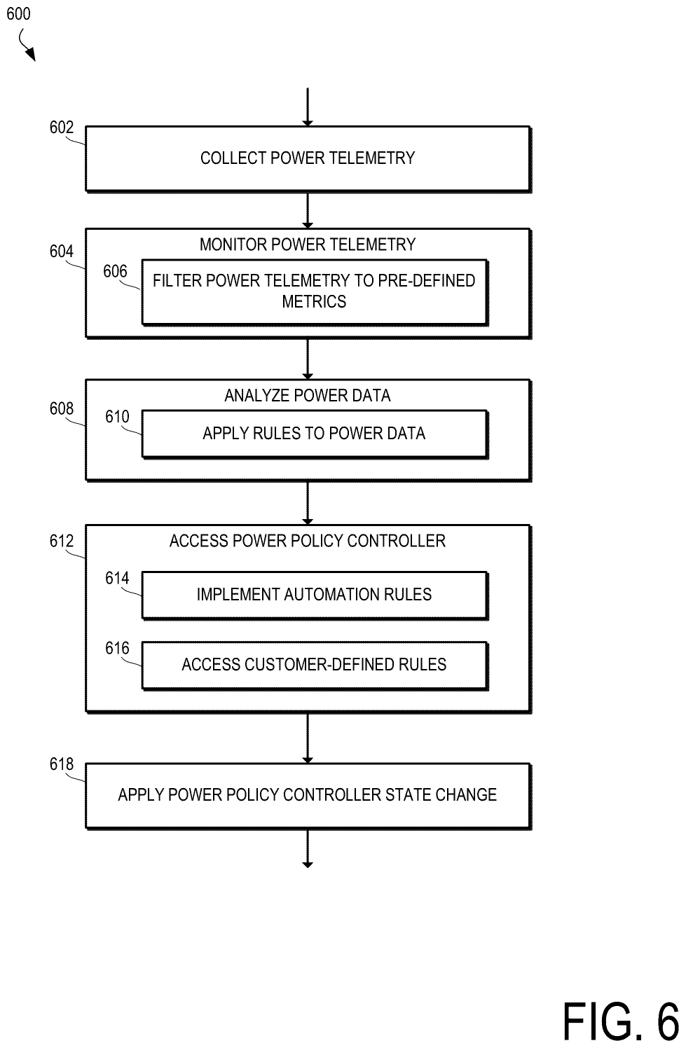

Referring now to FIG. 6, in use, a compute node 102 and/or orchestrator node 104 may execute a method 600 for managing power in one or more compute nodes 102. The method 600 begins in block 602, in which the compute node 102 collects power telemetry related to one or more processors 202, processor cores, or other components of the compute node 102. The compute node 102 may collect, e.g., processor frequency (e.g., current operational frequency of CPU core and/or CPU core busy frequency measured as frequency adjusted to CPU core busy cycles), processor and/or core temperature, state residency data such as cpu_c1_state_residency and/or cpu_c6_state_residency data (e.g., percentage of time CPU core spent in C1 core residency state and/or percentage of time CPU core spent in C6 core residency state), processor busy cycles (e.g., CPU core busy cycles as a ratio of cycles spent in C0 state residency to all cycles executed by CPU core), etc., for each processor 202 and/or processor core of the compute node 102. Additionally or alternatively, in some embodiments, the compute node 102 may collect per node data, such as the maximum thermal design power available for the processor package, current power consumption of the processor package, and current power consumption of the processor package DRAM subsystem. In an illustrative embodiment, the compute node 102 sends the telemetry data to the orchestrator node 104 over the network 106. Additionally or alternatively, in some embodiments, some or all of the filtering and/or analysis performed in, e.g., blocks 604-610, may be performed by the compute node 102 or another intermediate node, such as an edge node, which reduces bandwidth requirements for the power telemetry data.

In block 604, the orchestrator node 104 monitors power telemetry received from the compute node 102. The orchestrator node 104 may filter power telemetry data to key metrics in block 606, which may be pre-defined. Use of key metrics can be important for scaling to large deployments. The orchestrator node 104 may filter for input based on the use case being implemented in the rule's entity.

In block 608, the orchestrator node 104 analyzes the power data. The orchestrator node 104 may use rules to assess clusters/nodes/processors/processor cores as idle or unallocated in block 610. The orchestrator node 104 can use the monitored telemetry to identify isolated processors and/or cores that are not utilized as stranded processors and/or cores, as well as to identify non-isolated processors and/or cores that are rarely utilized as zombie processors and/or cores. The orchestrator node 104 may use a recommendation function to estimate the power savings that can be achieved on these processors and cores by putting them into lower power states. The orchestrator node 104 may use an interface to a scheduler such as Kubernetes to query unallocated physical cores and, in some embodiments, mark these cores as low-power to the scheduler. The orchestrator node 104 may recommend a power policy to be applied to the platform.

The orchestrator node 104 may use recommendation system rules to identify the idle status of the core. The rules to determine power saving opportunity (which may be referred to as recommendation engine and controller rules) may, in some embodiments, include some or all of the following. In one embodiment, a core/CPU is considered busy (polling core) if, during a 24-hour time window, core/CPU average utilization over time is over a threshold amount, such as 90%-99% (that is, the core constantly doing a lot of work), and CPU maximum utilization over time is at least a threshold amount, such as 95%-100% (that is, the core/CPU peaks to full utilization). In another embodiment, a core/CPU is considered idle (and therefore a candidate for power saving) if, during a 24-hour time window, the CPU/core average utilization over time is less than a threshold amount, such as 1%-10% (that is, it is idle most of the time, without significant load), and if CPU/core maximum utilization over time is less than a threshold amount, such as 2%-15% (that is, it is not used periodically/by schedule (e.g. via cron) to do any substantial work). Additionally or alternatively, in another embodiment, a core/CPU is considered an ordinary worker if neither of the two previous rules apply.

The orchestrator node 104 accepts as an input the per-core power in order to recommend the savings possible prior to taking a decision on making a change. To determine the per-core power, various approaches may be used. The approaches may vary depending on the type of processor being used. The per-core watts estimate described below may be used as a basis for savings calculations. The approach described below is merely one possible embodiment, and other embodiments are envisioned as well. In general, any suitable approach may be used to determine a per-core amount of power based on factors such as core frequency, total processor 202 power, and parameters estimating the amount of power used by the cores and the amount of fixed power used by each core.

In one embodiment, a certain fraction of the running average power limit (RAPL)-based package power is assumed to be consumed by cores of the processor 202. For example, the fraction may be 60%, in one embodiment. In that case, a 10-core processor 202 that consumes 100 Watts based on the RAPL, 60 Watts is assumed to be consumed by the cores of the processor 202. In other embodiments, it may be 40%-80% of the RAPL that is assumed to be consumed by cores of the processor 202. A fraction of the amount of the power assigned to the cores is then assigned evenly to the cores. That fraction may be, e.g., 30%-70%. In one embodiment, that fraction is 50%. For example, if 60 Watts is assigned to the 10 cores of a processor 202, then half of that amount (that is, 30 Watts) may be assigned evenly to the 10 cores, or 3 Watts per core. The remaining fraction of the amount of the power assigned to the cores is then distributed among the cores proportionally to the frequency that each core is operating at. For example, if 8 of the 10 cores are operating at 1 GHz and 2 of the 10 cores are operating at 2 GHz, the 1 GHz cores will each be assigned a consumption of 30 Watts*(1 GHz/core/(8 cores*1 GHz/core+2 cores*2 GHz/core))=2.5 Watts/core of frequency-based power consumption. The remaining 2 of the 10 cores operating at 2 GHz will each be assigned a consumption of 30 Watts*(2 GHz/core/(8 cores*1 GHz/core+2 cores*2 GHz/core))=5 Watts/core of frequency-based power consumption.

In block 612, the orchestrator node 104 accesses the power policy controller. The power policy controller may implement automation rules in block 614 and/or implement customer-defined rules in block 616. For example, in one embodiment, the power policy controller may, on day 0, with use case of power reduction for server pre-orchestration deployment where a server is stood up and not in service, the action may be power profile provisioning/configuration, e.g., set a low-power mode. In another example, in one embodiment, the power policy controller may, on day 1, with use case of power reduction for server post-orchestration deployment, wherein the server is stood up, the platform in service, and no workload running, the action may be to idle resource identification and power reduction, with a local or remote decision possible.

In block 618, the state change from the power policy controller is implemented, such as by sending an instruction from the orchestrator node 104 to the compute node 102. The power agent 408 may apply the power policy recommendations. The power agent 408 may use profiles to implement power control using, e.g., Power Management Technology including P states, C states, and/or Uncore Scaling. In some embodiments, the orchestrator node 104 and/or the compute node 102 may implement a programmable API to implement power control actions.

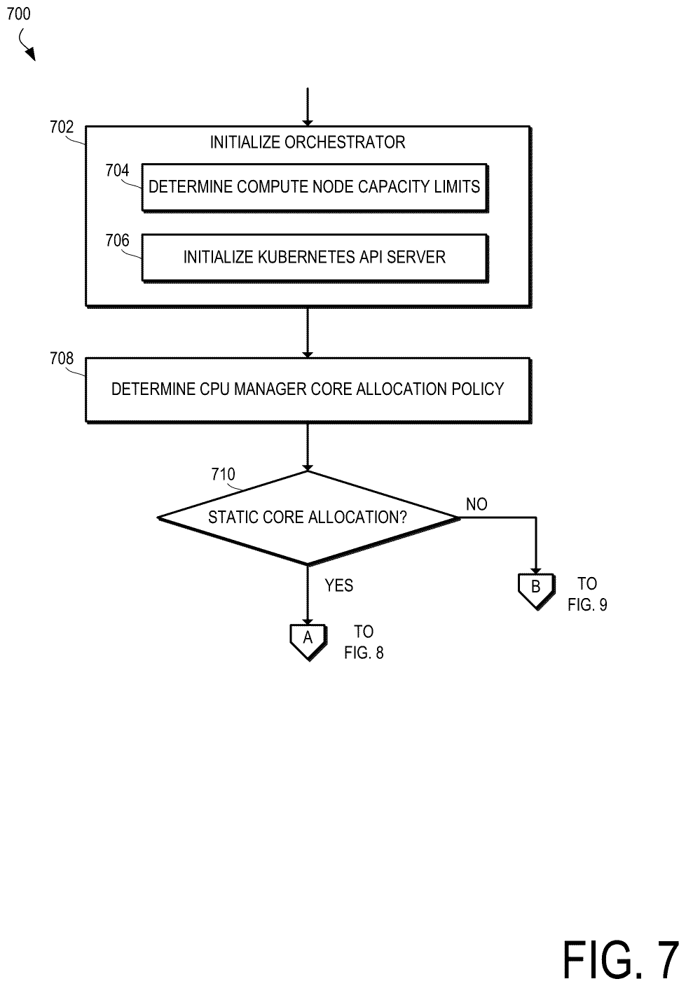

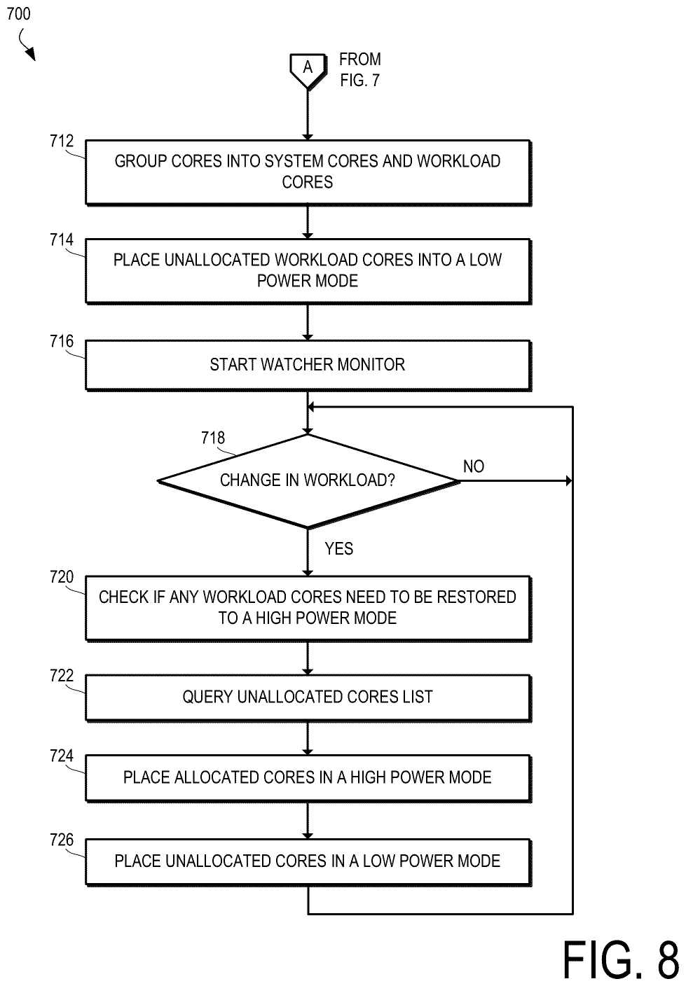

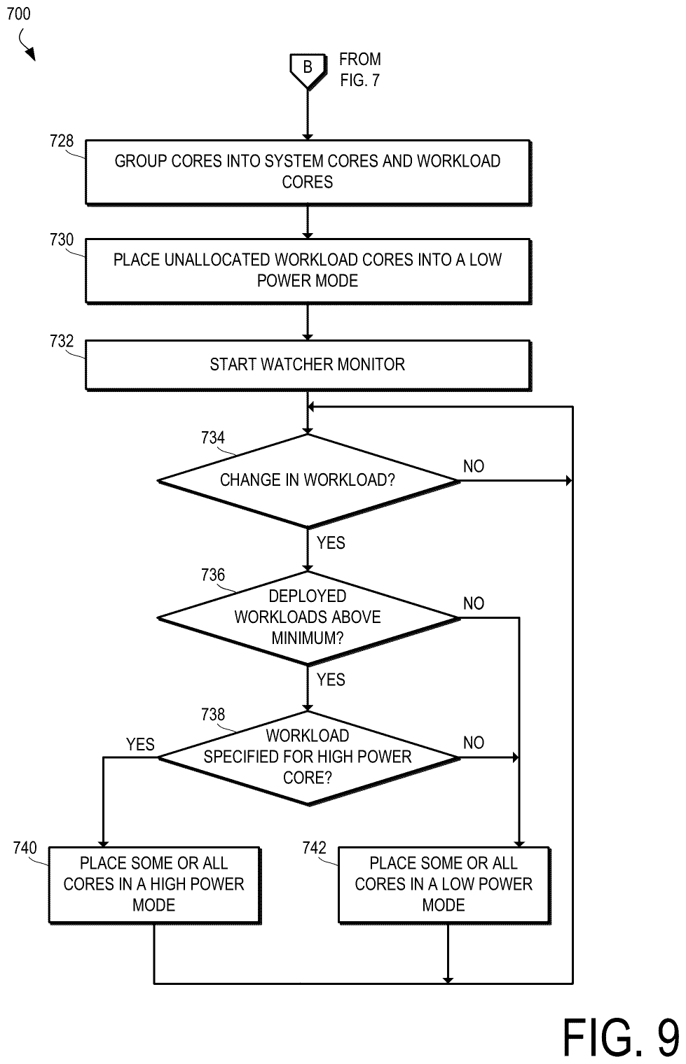

Referring now to FIG. 7, in use, a compute node 102 and/or orchestrator node 104 may execute a method 700 for managing power in one or more compute nodes 102. The various blocks of the method 700 may be performed by the compute node 102, the orchestrator node 104, and/or a combination thereof, including orchestration software running on the orchestrator node 104 and/or the compute node 102. In an illustrative embodiment, the orchestration software may be Kubernetes®. The various functions described herein may be performed by any suitable aspect of a Kubernetes® system, such as a kube API server, kube-sheduler, kube-controller-manager, cloud-controller-manager, kubelets, kube-proxy, etc. Additionally or alternatively, in other embodiments, different orchestration software may be used, such as Docker/Docker Swarm, Apache Mesos with or without Marathon, Nomad, OpenShift, Rancher, Portainer, Consul, Helm, and/or the like. In some cases, an operation may be described as being performed by one component, such as the orchestrator node 104. It should be appreciated that, in many cases, the tasks of the method 700 may be performed additionally or alternatively by the compute node 102. In some embodiments, the method 700 may be performed as part of setting up or staging a data center, such as during the time when components are initially powered on as part of a pre-production rollout of services but before workloads may be deployed on the cores of the data center at scale.

The method 700 begins in block 702, in which an orchestrator node 104 is initialized. In block 704, the orchestrator node 104 may determine compute node capacity limits, such as the number of compute nodes 102 available and the number of processors 202 and processor cores available. In an illustrative embodiment, in block 706, the orchestrator node 104 initializes a Kubernetes® API server.

In block 708, the orchestrator node 104 determines a CPU manager core allocation policy. The policy may be the same for each compute node 102, or the policy may be different for the different compute nodes. In an illustrative embodiment, there are two possible configurations corresponding to two possible settings for a cpuManagePolicy parameter. In one configuration, the cpuManagerPolicy may be set to “static,” and the orchestrator software on the compute node 102 allocates individual cores of the processor 202 of the compute node 102 to pods with exclusivity. If the cpuManagerPolicy is set to “none,” the cores 502 are allocated using a general scheduler controlled by the operating system with no specific allocation of cores to pods.

In block 710, if the core allocation is static, the method 700 proceeds to block 712 in FIG. 8, in which the cores of the compute node 102 are grouped into system cores and workload cores. The system cores may perform functions such as operating system function, orchestrator node software functions, etc., and the workload cores may perform workloads deployed to the compute node 102 by the orchestrator node 104. In an illustrative embodiment, the workload cores are controlled by the orchestrator agent operating on the compute node 102.

In block 714, the workload cores, which are initially unallocated, may be placed into a low-power mode. For example, clock gating may be used, power gating may be used, dynamic voltage and frequency scaling (DVFS) may be used, etc. In some embodiments, sleep modes may be used, in which cores can enter progressively deeper levels of power saving. For example, in one embodiment, a core may have sleep modes C0 (an active state, in which the core is fully operational), C1 (a halt state, in which the core is not executing instructions but can quickly resume activity), C2 (a stop-clock state, in which the clock to the core is stopped, saving more power but taking longer to resume activity), C3 (a sleep state, in which the core is put to sleep, with its cache memory retained but most other functions powered down), and C6 (a deep power down state, in which the core's state is saved and the power is cut off almost entirely, which saves the most power but requires the longest time to wake up). When a core is placed into a low-power state, the core may be placed into any suitable low-power state, such as C1, C2, C3, C6, etc. In an illustrative embodiment, in block 714, the unallocated cores are placed into a C6 state.

In block 716, the compute node 102 starts a watcher monitor to monitor for incoming and outgoing workloads/pods deployed to and removed from the compute node 102. The watcher monitor can read the specification of incoming pods, including the name of the incoming pods, decide on the priority of pods, such as deciding on the priority of pods based on the name of the pod, count pods to determine if any workloads are running, implement logic to apply power optimization methods, and/or the like.

In block 718, if there is no change in workload, the method 700 loops back to block 718 to continue monitoring for changes in the workloads. If there is a change in the workload, the method 700 proceeds to block 720, in which the compute node 102 checks if any workload cores need to be restored to a high-power mode. For example, if a pod was assigned to a core in a low-power mode, the compute node 102 may place that core into a higher power mode, such as an operational or full power mode (e.g., in state C0). Additionally or alternatively, if a pod is removed from a core, the compute node 102 may place that core into a low-power mode.

In some embodiments, in block 722, the compute node 102 queries an unallocated cores list to check for unallocated cores. The compute node 102 may perform the query after a change in workload is detected and/or may perform the query periodically, continuously, or continually. In an illustrative embodiment, a query to find the allocated cores is only achievable for static kubelet configurations. The unallocated can be determined from the list of allocated cores. In some embodiments, to perform a query, a new controller is deployed as a pod. The controller can interact with an orchestrator such as Kubernetes® and can determine which cores are allocated and unallocated. The controller may run a query via the CPU manage state file to return the allocated cores on a given CPU via CPU manager reading and by parsing a file. In an illustrative embodiment, the file may be located at/var/lib/kubelet/cpu_manager_state. This file can be used to query the allocated cores and determine the unallocated cores. In another embodiment, the compute node 102 performs an API query to determine which cores of a processor 202 are allocated.

In block 724, the compute node 102 places the allocated cores in a high-power mode, such as C0. In block 726, the compute node 102 places the unallocated cores in a low-power mode, such as C6. In some embodiments, if all cores are unallocated, the compute node 102 may trigger a low-power mode for the CPU cores, uncore or platform accelerators, and/or GPUs. The method 700 then loops back to block 718 to continue monitoring for changes to the workloads.

Referring back to block 710 in FIG. 7, if the core allocation is not static, the method 700 proceeds to block 728 in FIG. 9, in which the cores of the compute node 102 are grouped into system cores and workload cores. In block 730, the workload cores, which are initially unallocated, may be placed into a low-power mode.

In block 732, the compute node 102 starts a watcher monitor to monitor for incoming and outgoing workloads/pods deployed to and removed from the compute node 102. The watcher monitor can read the specification of incoming pods, including the name of the incoming pods, decide on the priority of pods, such as deciding on the priority of pods based on the name of the pod, count pods to determine if any workloads are running, implement logic to apply power optimization methods, and/or the like. The compute node 102 may configure the watcher monitor or other component to control how cores will be placed into low- and high-power modes. For example, a parameter may be set for a threshold number of pods deployed to the processor, such as 0-5 pods, under which some or all of the cores of a processor may be placed in a low-power state. Additionally or alternatively, a user may specify a list of pod names, and when a pod matching that list is deployed, certain actions may be taken, such as placing some or all of the cores in a low- or high-power state. The watcher monitor may access the parameter for the threshold number of pods and one or more such lists of pod names.

In block 734, if there is no change in workload, the method 700 loops back to block 734 to continue monitoring for changes in the workloads. If there is a change in the workload, the method 700 proceeds to block 736, in which the compute node 102 checks if the number of deployed pods is above a minimum threshold, such as the user-defined threshold referred to above. If the deployed workloads are not above a minimum threshold, the method 700 proceeds to block 742, in which some or all of the cores are placed in a low-power mode. In some embodiments, if all cores are unallocated, the compute node 102 may trigger a low-power mode for the CPU cores, uncore or platform accelerators, and/or GPUs. If the deployed workloads are above a minimum threshold, the method 700 proceeds to block 738.

In block 738, in an illustrative embodiment, if the workload is specified for a high-power core, such as by having a name that is on a list provided by a user or by having a parameter associated with it indicating a high-power core, the method 700 proceeds to block 740, in which some or all of the cores of the processor 202 are placed in a high-power mode. If the workload is not specified for a high-power core, the method 700 proceeds to block 742, in which some or all of the cores may be placed in a low-power mode. The method 700 then loops back to block 734 to continue monitoring for changes to workloads.

### EXAMPLES

Illustrative examples of the technologies disclosed herein are provided below. An embodiment of the technologies may include any one or more, and any combination of, the examples described below.

Example 1 includes a orchestrator node comprising a processor; a memory; one or more computer-readable media comprising a plurality of instructions stored thereon that, when executed by the orchestrator node, cause the orchestrator node to receive power telemetry data indicative of power usage data for a compute node; analyze the power telemetry data, wherein to analyze the power telemetry data comprises to use rules to identify one or more processors and/or one or more processor cores as idle or unallocated; apply one or more automation rules to the analyzed power telemetry data to determine one or more power state changes for the compute node; and instruct the compute node to implement the one or more power state changes.

Example 2 includes the subject matter of Example 1, and wherein the plurality of instructions further cause the orchestrator node to apply one or more filters to the power telemetry data to identify one or more pre-defined metrics, wherein to analyze the power telemetry data comprises to analyze the one or more pre-defined metrics.

Example 3 includes the subject matter of any of Examples 1 and 2, and wherein the power telemetry data includes a frequency of a processor of the compute node, a temperature of a processor of the compute node, a power state residency of the compute node, and processor core busy cycles of a processor of the compute node.

Example 4 includes the subject matter of any of Examples 1-3, and wherein the power telemetry data includes a maximum thermal design power available for a processor package of the compute node, a current power consumption of a processor package of the compute node, and a current power consumption of a processor package memory subsystem.

Example 5 includes the subject matter of any of Examples 1-4, and wherein to analyze the power telemetry data comprises to identify one or more isolated processors and/or processor cores that are not utilized as stranded processors and/or stranded processor cores.

Example 6 includes the subject matter of any of Examples 1-5, and wherein to analyze the power telemetry data comprises to identify one or more non-isolated processors and/or processor cores that are rarely utilized as zombie processors and/or zombie processor cores.

Example 7 includes the subject matter of any of Examples 1-6, and wherein the plurality of instructions further cause the orchestrator node to mark one or more processors and/or processor cores of the compute node as at least partially available in a scheduler in response to analysis of the power telemetry data.

Example 8 includes the subject matter of any of Examples 1-7, and wherein the one or more automation rules consider average utilization of a processor or processor core over a period of time and maximum utilization of a processor or processor core over a period of time.

Example 9 includes the subject matter of any of Examples 1-8, and wherein the one or more automation rules consider average utilization of a processor or processor core over a period of time and maximum utilization of a processor or processor core over a period of time to label a processor or processor core as busy, ordinary, or idle.

Example 10 includes the subject matter of any of Examples 1-9, and wherein to analyze the power telemetry data comprises to determine a base power consumption and a frequency-based power consumption for individual processor cores of a plurality of processor cores of a processor of the compute node.

Example 11 includes a system comprising the orchestrator node of any of Examples 1-10, further comprising the compute node, the compute node comprising a processor; a memory; one or more computer-readable media comprising a second plurality of instructions stored thereon that, when executed by the compute node, cause the compute node to allocate a plurality of cores of the processor to an orchestrator, wherein the orchestrator is configured to statically allocate cores of the plurality of cores to workloads deployed to the compute node; receive one or more workloads; statically allocate individual cores of the plurality of cores to the one or more workloads; and place unallocated cores of the plurality of cores in a low-power mode.

Example 12 includes the subject matter of Example 11, and wherein a cpuManagerPolicy setting of a Kubelet of a Kubernetes orchestrator is configured to static.

Example 13 includes the subject matter of any of Examples 11 and 12, and wherein the second plurality of instructions further cause the compute node to monitor for a removal of a workload from the compute node; and place an unallocated core corresponding to the removed workload in a low-power mode in response to removal of the workload.

Example 14 includes the subject matter of any of Examples 11-13, and wherein the second plurality of instructions further cause the compute node to monitor for a deployment of a workload to the compute node; and place an allocated core corresponding to the deployed workload in a high-power mode in response to removal of the workload.

Example 15 includes the subject matter of any of Examples 11-14, and wherein the second plurality of instructions further cause the compute node to query a processor manager state file associated with the orchestrator, wherein the processor manage state file indicates workloads statically deployed to cores of the plurality of cores; determine unallocated cores of the plurality of cores based on the processor manage state file; and place the unallocated cores of the plurality of cores in a low-power state.

Example 16 includes the subject matter of any of Examples 11-15, and wherein the second plurality of instructions further cause the compute node to perform an API query to an orchestrator component; determine unallocated cores of the plurality of cores based on the API query; and place the unallocated cores of the plurality of cores in a low-power state.

Example 17 includes a compute node comprising a processor; a memory; one or more computer-readable media comprising a plurality of instructions stored thereon that, when executed by the orchestrator node, cause the compute node to analyze one or more compute nodes of a data center; determine whether one or more processor cores of one or more processors of the one or more compute nodes of the data center should be placed into a low-power mode based on the analysis of the one or more compute nodes; and place the one or more processor cores of the one or more processors of the one or more compute nodes into the low-power mode in response to a determination that the one or more processor cores of the one or more processors of the one or more compute nodes should be placed into the low-power mode.

Example 18 includes the subject matter of Example 17, and wherein the plurality of instructions further cause the compute node to allocate a plurality of cores of a processor of the compute node to an orchestrator, wherein the orchestrator is configured to statically allocate cores of the plurality of cores to workloads deployed to the compute node; receive one or more workloads; statically allocate individual cores of the plurality of cores to the one or more workloads; and place unallocated cores of the plurality of cores in a low-power mode.

Example 19 includes the subject matter of any of Examples 17 and 18, and wherein a cpuManagerPolicy setting of a Kubelet of a Kubernetes orchestrator is configured to static.

Example 20 includes the subject matter of any of Examples 17-19, and wherein the plurality of instructions further cause the compute node to monitor for a removal of a workload from the compute node; and place an unallocated core corresponding to the removed workload in a low-power mode in response to removal of the workload.

Example 21 includes the subject matter of any of Examples 17-20, and wherein the plurality of instructions further cause the compute node to monitor for a deployment of a workload to the compute node; and place an allocated core corresponding to the deployed workload in a high-power mode in response to removal of the workload.

Example 22 includes the subject matter of any of Examples 17-21, and wherein the plurality of instructions further cause the compute node to query a processor manager state file associated with the orchestrator, wherein the processor manage state file indicates workloads statically deployed to cores of the plurality of cores; determine unallocated cores of the plurality of cores based on the processor manage state file; and place the unallocated cores of the plurality of cores in a low-power state.

Example 23 includes the subject matter of any of Examples 17-22, and wherein the plurality of instructions further cause the compute node to perform an API query to an orchestrator component; determine unallocated cores of the plurality of cores based on the API query; and place the unallocated cores of the plurality of cores in a low-power state.

Example 24 includes the subject matter of any of Examples 17-23, and wherein the plurality of instructions further cause the compute node to allocate a plurality of cores of a processor of the compute node to an orchestrator, wherein the orchestrator is configured to not statically allocate cores of the plurality of cores to workloads deployed to the compute node; determine a number of workloads deployed to the processor and/or an indication of whether workloads deployed to the processor should be deployed to cores in a specified power state; and place cores of the plurality of cores in a power state based on the determination of a number of workloads deployed to the processor and/or an indication of whether workloads deployed to the processor should be deployed to cores in a specified power state.

Example 25 includes the subject matter of any of Examples 17-24, and wherein a cpuManagerPolicy setting of a Kubelet of a Kubernetes orchestrator is configured to none.

Example 26 includes the subject matter of any of Examples 17-25, and wherein the plurality of instructions further cause the compute node to determine a number of workloads deployed to the processor; determine whether the number of workloads deployed to the processor is above a pre-determined user-defined threshold amount; and place one or more of the plurality of cores in a low power state based on a determination that the number of workloads deployed to the processor is not above the pre-determined user-defined threshold amount.

Example 27 includes the subject matter of any of Examples 17-26, and wherein the plurality of instructions further cause the compute node to determine a number of workloads deployed to the processor; determine whether the number of workloads deployed to the processor is above a pre-determined user-defined threshold amount; and place one or more of the plurality of cores in a high-power state based on a determination that the number of workloads deployed to the processor is above the pre-determined user-defined threshold amount.

Example 28 includes the subject matter of any of Examples 17-27, and wherein the plurality of instructions further cause the compute node to determine an indication of whether workloads deployed to the processor should be in a specified power state; and place one or more of the plurality of cores in a specified power state based on the indication of whether workloads deployed to the processor should be in a specified power state.

Example 29 includes the subject matter of any of Examples 17-28, and wherein to determine an indication of whether workloads deployed to the processor should be in a specified power state comprises to determine whether a name of a workload is on a list stored on the compute node.

Example 30 includes the subject matter of any of Examples 17-29, and wherein the compute node is an orchestrator node, further comprising receive, by the orchestrator node, power telemetry data indicative of power usage data for the one or more compute nodes, wherein to analyze the one or more compute nodes of the data center comprises to analyze the power telemetry data.

Example 31 includes the subject matter of any of Examples 17-30, and wherein the plurality of instructions further cause the compute node to apply one or more filters to the power telemetry data to identify one or more pre-defined metrics, wherein to analyze the power telemetry data comprises to analyze the one or more pre-defined metrics.

Example 32 includes the subject matter of any of Examples 17-31, and wherein the power telemetry data includes a frequency of a processor of the compute node, a temperature of a processor of the compute node, a power state residency of the compute node, and processor core busy cycles of a processor of the compute node.

Example 33 includes the subject matter of any of Examples 17-32, and wherein the power telemetry data includes a maximum thermal design power available for a processor package of the compute node, a current power consumption of a processor package of the one or more compute nodes, and a current power consumption of a processor package memory subsystem.

Example 34 includes the subject matter of any of Examples 17-33, and wherein to analyze the power telemetry data comprises to identify one or more isolated processors and/or processor cores that are not utilized as stranded processors and/or stranded processor cores.

Example 35 includes the subject matter of any of Examples 17-34, and wherein to analyze the power telemetry data comprises to identify one or more non-isolated processors and/or processor cores that are rarely utilized as zombie processors and/or zombie processor cores.

Example 36 includes the subject matter of any of Examples 17-35, and wherein the plurality of instructions further cause the compute node to mark one or more processors and/or processor cores of the one or more compute nodes as at least partially available in a scheduler in response to analysis of the power telemetry data.

Example 37 includes the subject matter of any of Examples 17-36, and wherein the one or more automation rules consider average utilization of a processor or processor core over a period of time and maximum utilization of a processor or processor core over a period of time.

Example 38 includes the subject matter of any of Examples 17-37, and wherein the one or more automation rules consider average utilization of a processor or processor core over a period of time and maximum utilization of a processor or processor core over a period of time to label a processor or processor core as busy, ordinary, or idle.

Example 39 includes the subject matter of any of Examples 17-38, and wherein to analyze the power telemetry data comprises to determine a base power consumption and a frequency-based power consumption for individual processor cores of a plurality of processor cores of a processor of the compute node.

Example 40 includes a method comprising analyzing, by a compute node, one or more compute nodes of a data center; determining, by the compute node, whether one or more processor cores of one or more processors of the one or more compute nodes of the data center should be placed into a low-power mode based on the analysis of the one or more compute nodes; and placing, by the compute node, the one or more processor cores of the one or more processors of the one or more compute nodes into the low-power mode in response to a determination that the one or more processor cores of the one or more processors of the one or more compute nodes should be placed into the low-power mode.

Example 41 includes the subject matter of Example 40, and further including allocating a plurality of cores of a processor of the compute node to an orchestrator, wherein the orchestrator is configured to statically allocate cores of the plurality of cores to workloads deployed to the compute node; receiving, by the compute node, one or more workloads; statically allocating, by the compute node, individual cores of the plurality of cores to the one or more workloads; and placing, by the compute node, unallocated cores of the plurality of cores in a low-power mode.

Example 42 includes the subject matter of any of Examples 40 and 41, and wherein a cpuManagerPolicy setting of a Kubelet of a Kubernetes orchestrator is configured to static.

Example 43 includes the subject matter of any of Examples 40-42, and further including monitoring, by the compute node, for a removal of a workload from the compute node; and placing, by the compute node, an unallocated core corresponding to the removed workload in a low-power mode in response to removal of the workload.

Example 44 includes the subject matter of any of Examples 40-43, and further including monitoring, by the compute node, for a deployment of a workload to the compute node; and placing, by the compute node, an allocated core corresponding to the deployed workload in a high-power mode in response to removal of the workload.

Example 45 includes the subject matter of any of Examples 40-44, and further including querying, by the compute node, a processor manage state file associated with the orchestrator, wherein the processor manage state file indicates workloads statically deployed to cores of the plurality of cores; determining, by the compute node, unallocated cores of the plurality of cores based on the processor manage state file; and placing, by the compute node, the unallocated cores of the plurality of cores in a low-power state.

Example 46 includes the subject matter of any of Examples 40-45, and further including performing, by the compute node, an API query to an orchestrator component; determining, by the compute node, unallocated cores of the plurality of cores based on the API query; and placing, by the compute node, the unallocated cores of the plurality of cores in a low-power state.

Example 47 includes the subject matter of any of Examples 40-46, and further including allocating a plurality of cores of a processor of the compute node to an orchestrator, wherein the orchestrator is configured to not statically allocate cores of the plurality of cores to workloads deployed to the compute node; determining, by the compute node, a number of workloads deployed to the processor and/or an indication of whether workloads deployed to the processor should be deployed to cores in a specified power state; and placing, by the compute node, cores of the plurality of cores in a power state based on the determination of a number of workloads deployed to the processor and/or an indication of whether workloads deployed to the processor should be deployed to cores in a specified power state.

Example 48 includes the subject matter of any of Examples 40-47, and wherein a cpuManagerPolicy setting of a Kubelet of a Kubernetes orchestrator is configured to none.

Example 49 includes the subject matter of any of Examples 40-48, and further including determining, by the compute node, a number of workloads deployed to the processor; determining, by the compute node, whether the number of workloads deployed to the processor is above a pre-determined user-defined threshold amount; and placing, by the compute node, one or more of the plurality of cores in a low power state based on a determination that the number of workloads deployed to the processor is not above the pre-determined user-defined threshold amount.

Example 50 includes the subject matter of any of Examples 40-49, and further including determining, by the compute node, a number of workloads deployed to the processor; determining, by the compute node, whether the number of workloads deployed to the processor is above a pre-determined user-defined threshold amount; and placing, by the compute node, one or more of the plurality of cores in a high-power state based on a determination that the number of workloads deployed to the processor is above the pre-determined user-defined threshold amount.

Example 51 includes the subject matter of any of Examples 40-50, and further including determining, by the compute node, an indication of whether workloads deployed to the processor should be in a specified power state; and placing, by the compute node, one or more of the plurality of cores in a specified power state based on the indication of whether workloads deployed to the processor should be in a specified power state.

Example 52 includes the subject matter of any of Examples 40-51, and wherein determining, by the compute node, an indication of whether workloads deployed to the processor should be in a specified power state comprises determining whether a name of a workload is on a list stored on the compute node.

Example 53 includes the subject matter of any of Examples 40-52, and wherein the compute node is an orchestrator node, further comprising receiving, by the orchestrator node, power telemetry data indicative of power usage data for the one or more compute nodes, wherein analyzing the one or more compute nodes of the data center comprises analyzing the power telemetry data.

Example 54 includes the subject matter of any of Examples 40-53, and further including applying one or more filters to the power telemetry data to identify one or more pre-defined metrics, wherein analyzing the power telemetry data comprises analyzing the one or more pre-defined metrics.

Example 55 includes the subject matter of any of Examples 40-54, and wherein the power telemetry data includes a frequency of a processor of the compute node, a temperature of a processor of the compute node, a power state residency of the compute node, and processor core busy cycles of a processor of the compute node.

Example 56 includes the subject matter of any of Examples 40-55, and wherein the power telemetry data includes a maximum thermal design power available for a processor package of the compute node, a current power consumption of a processor package of the one or more compute nodes, and a current power consumption of a processor package memory subsystem.

Example 57 includes the subject matter of any of Examples 40-56, and wherein analyzing the power telemetry data comprises identifying one or more isolated processors and/or processor cores that are not utilized as stranded processors and/or stranded processor cores.

Example 58 includes the subject matter of any of Examples 40-57, and wherein analyzing the power telemetry data comprises identifying one or more non-isolated processors and/or processor cores that are rarely utilized as zombie processors and/or zombie processor cores.

Example 59 includes the subject matter of any of Examples 40-58, and further including marking one or more processors and/or processor cores of the one or more compute nodes as at least partially available in a scheduler in response to analysis of the power telemetry data.

Example 60 includes the subject matter of any of Examples 40-59, and wherein the one or more automation rules consider average utilization of a processor or processor core over a period of time and maximum utilization of a processor or processor core over a period of time.

Example 61 includes the subject matter of any of Examples 40-60, and wherein the one or more automation rules consider average utilization of a processor or processor core over a period of time and maximum utilization of a processor or processor core over a period of time to label a processor or processor core as busy, ordinary, or idle.

Example 62 includes the subject matter of any of Examples 40-61, and wherein analyzing the power telemetry data comprises determining a base power consumption and a frequency-based power consumption for individual processor cores of a plurality of processor cores of a processor of the compute node.

Example 63 includes a method comprising receiving, by a orchestrator node, power telemetry data indicative of power usage data for a compute node; analyzing, by the orchestrator node, the power telemetry data, wherein analyzing the power telemetry data comprises using rules to identify one or more processors and/or one or more processor cores as idle or unallocated; applying, by the orchestrator node, one or more automation rules to the analyzed power telemetry data to determine one or more power state changes for the compute node; and instructing, by the orchestrator node, the compute node to implement the one or more power state changes.

Example 64 includes the subject matter of Example 63, and further including applying one or more filters to the power telemetry data to identify one or more pre-defined metrics, wherein analyzing the power telemetry data comprises analyzing the one or more pre-defined metrics.

Example 65 includes the subject matter of any of Examples 63 and 64, and wherein the power telemetry data includes a frequency of a processor of the compute node, a temperature of a processor of the compute node, a power state residency of the compute node, and processor core busy cycles of a processor of the compute node.

Example 66 includes the subject matter of any of Examples 63-65, and wherein the power telemetry data includes a maximum thermal design power available for a processor package of the compute node, a current power consumption of a processor package of the compute node, and a current power consumption of a processor package memory subsystem.

Example 67 includes the subject matter of any of Examples 63-66, and wherein analyzing the power telemetry data comprises identifying one or more isolated processors and/or processor cores that are not utilized as stranded processors and/or stranded processor cores.

Example 68 includes the subject matter of any of Examples 63-67, and wherein analyzing the power telemetry data comprises identifying one or more non-isolated processors and/or processor cores that are rarely utilized as zombie processors and/or zombie processor cores.

Example 69 includes the subject matter of any of Examples 63-68, and further including marking one or more processors and/or processor cores of the compute node as at least partially available in a scheduler in response to analysis of the power telemetry data.

Example 70 includes the subject matter of any of Examples 63-69, and wherein the one or more automation rules consider average utilization of a processor or processor core over a period of time and maximum utilization of a processor or processor core over a period of time.

Example 71 includes the subject matter of any of Examples 63-70, and wherein the one or more automation rules consider average utilization of a processor or processor core over a period of time and maximum utilization of a processor or processor core over a period of time to label a processor or processor core as busy, ordinary, or idle.

Example 72 includes the subject matter of any of Examples 63-71, and wherein analyzing the power telemetry data comprises determining a base power consumption and a frequency-based power consumption for individual processor cores of a plurality of processor cores of a processor of the compute node.

Example 73 includes the subject matter of any of Examples 63-72, and further including allocating a plurality of cores of a processor of the compute node to an orchestrator, wherein the orchestrator is configured to statically allocate cores of the plurality of cores to workloads deployed to the compute node; receiving, by the compute node, one or more workloads; statically allocating, by the compute node, individual cores of the plurality of cores to the one or more workloads; and placing, by the compute node, unallocated cores of the plurality of cores in a low-power mode.

Example 74 includes the subject matter of any of Examples 63-73, and wherein a cpuManagerPolicy setting of a Kubelet of a Kubernetes orchestrator is configured to static.

Example 75 includes the subject matter of any of Examples 63-74, and further including monitoring, by the compute node, for a removal of a workload from the compute node; and placing, by the compute node, an unallocated core corresponding to the removed workload in a low-power mode in response to removal of the workload.

Example 76 includes the subject matter of any of Examples 63-75, and further including monitoring, by the compute node, for a deployment of a workload to the compute node; and placing, by the compute node, an allocated core corresponding to the deployed workload in a high-power mode in response to removal of the workload.

Example 77 includes the subject matter of any of Examples 63-76, and further including querying, by the compute node, a processor manage state file associated with the orchestrator, wherein the processor manage state file indicates workloads statically deployed to cores of the plurality of cores; determining, by the compute node, unallocated cores of the plurality of cores based on the processor manage state file; and placing, by the compute node, the unallocated cores of the plurality of cores in a low-power state.

Example 78 includes the subject matter of any of Examples 63-77, and further including performing, by the compute node, an API query to an orchestrator component; determining, by the compute node, unallocated cores of the plurality of cores based on the API query; and placing, by the compute node, the unallocated cores of the plurality of cores in a low-power state.

Example 79 includes a compute node comprising means for analyzing one or more processor cores of one or more processors of one or more compute nodes of a data center; and means for controlling power states of the one or more processor cores of the one or more processors of the one or more compute nodes based on the analysis of the one or more processor cores of the one or more processors of the one or more compute nodes.

Example 80 includes the subject matter of Example 79, and further including means for receiving, by a orchestrator node, power telemetry data indicative of power usage data for a compute node; means for analyzing the power telemetry data, wherein the means for analyzing the power telemetry data comprises means for using rules to identify one or more processors and/or one or more processor cores as idle or unallocated; means for applying one or more automation rules to the analyzed power telemetry data to determine one or more power state changes for the compute node; and means for instructing the compute node to implement the one or more power state changes.

Example 81 includes the subject matter of any of Examples 79 and 80, and further including means for allocating a plurality of cores of the processor to an orchestrator, wherein the orchestrator is configured to statically allocate cores of the plurality of cores to workloads deployed to the compute node; means for receiving one or more workloads; means for statically allocating individual cores of the plurality of cores to the one or more workloads; and means for placing unallocated cores of the plurality of cores in a low-power mode.

Example 82 includes a orchestrator node comprising means for receiving, by a orchestrator node, power telemetry data indicative of power usage data for a compute node; means for analyzing the power telemetry data, wherein the means for analyzing the power telemetry data comprises means for using rules to identify one or more processors and/or one or more processor cores as idle or unallocated; means for applying one or more automation rules to the analyzed power telemetry data to determine one or more power state changes for the compute node; and means for instructing the compute node to implement the one or more power state changes.

Example 83 includes the subject matter of Example 82, and further including means for applying one or more filters to the power telemetry data to identify one or more pre-defined metrics, wherein the means for analyzing the power telemetry data comprises means for analyzing the one or more pre-defined metrics.

Example 84 includes the subject matter of any of Examples 82 and 83, and wherein the power telemetry data includes a frequency of a processor of the compute node, a temperature of a processor of the compute node, a power state residency of the compute node, and processor core busy cycles of a processor of the compute node.

Example 85 includes the subject matter of any of Examples 82-84, and wherein the power telemetry data includes a maximum thermal design power available for a processor package of the compute node, a current power consumption of a processor package of the compute node, and a current power consumption of a processor package memory subsystem.

Example 86 includes the subject matter of any of Examples 82-85, and wherein the means for analyzing the power telemetry data comprises means for identifying one or more isolated processors and/or processor cores that are not utilized as stranded processors and/or stranded processor cores.

Example 87 includes the subject matter of any of Examples 82-86, and wherein the means for analyzing the power telemetry data comprises means for identifying one or more non-isolated processors and/or processor cores that are rarely utilized as zombie processors and/or zombie processor cores.

Example 88 includes the subject matter of any of Examples 82-87, and further including means for marking one or more processors and/or processor cores of the compute node as at least partially available in a scheduler in response to analysis of the power telemetry data.

Example 89 includes the subject matter of any of Examples 82-88, and wherein the one or more automation rules consider average utilization of a processor or processor core over a period of time and maximum utilization of a processor or processor core over a period of time.

Example 90 includes the subject matter of any of Examples 82-89, and wherein the one or more automation rules consider average utilization of a processor or processor core over a period of time and maximum utilization of a processor or processor core over a period of time to label a processor or processor core as busy, ordinary, or idle.

Example 91 includes the subject matter of any of Examples 82-90, and wherein the means for analyzing the power telemetry data comprises means for determining a base power consumption and a frequency-based power consumption for individual processor cores of a plurality of processor cores of a processor of the compute node.

Example 92 includes one or more computer-readable media comprising a plurality of instructions stored thereon that, when executed, causes a orchestrator node to receive power telemetry data indicative of power usage data for a compute node; analyze the power telemetry data, wherein to analyze the power telemetry data comprises to use rules to identify one or more processors and/or one or more processor cores as idle or unallocated; apply one or more automation rules to the analyzed power telemetry data to determine one or more power state changes for the compute node; and instruct the compute node to implement the one or more power state changes.

Example 93 includes the subject matter of Example 92, and wherein the plurality of instructions further cause the orchestrator node to apply one or more filters to the power telemetry data to identify one or more pre-defined metrics, wherein to analyze the power telemetry data comprises to analyze the one or more pre-defined metrics.

Example 94 includes the subject matter of any of Examples 92 and 93, and wherein the power telemetry data includes a frequency of a processor of the compute node, a temperature of a processor of the compute node, a power state residency of the compute node, and processor core busy cycles of a processor of the compute node.

Example 95 includes the subject matter of any of Examples 92-94, and wherein the power telemetry data includes a maximum thermal design power available for a processor package of the compute node, a current power consumption of a processor package of the compute node, and a current power consumption of a processor package memory subsystem.

Example 96 includes the subject matter of any of Examples 92-95, and wherein to analyze the power telemetry data comprises to identify one or more isolated processors and/or processor cores that are not utilized as stranded processors and/or stranded processor cores.

Example 97 includes the subject matter of any of Examples 92-96, and wherein to analyze the power telemetry data comprises to identify one or more non-isolated processors and/or processor cores that are rarely utilized as zombie processors and/or zombie processor cores.

Example 98 includes the subject matter of any of Examples 92-97, and wherein the plurality of instructions further cause the orchestrator node to mark one or more processors and/or processor cores of the compute node as at least partially available in a scheduler in response to analysis of the power telemetry data.

Example 99 includes the subject matter of any of Examples 92-98, and wherein the one or more automation rules consider average utilization of a processor or processor core over a period of time and maximum utilization of a processor or processor core over a period of time.

Example 100 includes the subject matter of any of Examples 92-99, and wherein the one or more automation rules consider average utilization of a processor or processor core over a period of time and maximum utilization of a processor or processor core over a period of time to label a processor or processor core as busy, ordinary, or idle.

Example 101 includes the subject matter of any of Examples 92-100, and wherein to analyze the power telemetry data comprises to determine a base power consumption and a frequency-based power consumption for individual processor cores of a plurality of processor cores of a processor of the compute node.

Example 102 includes a compute node comprising a processor; a memory; and one or more computer-readable media comprising a plurality of instructions stored thereon that, when executed by the compute node, cause the compute node to allocate one or more cores of the processor to a Kubernetes agent; determine, by the Kubernetes agent, whether the one or more cores of the processor allocated to the Kubernetes agent should be placed into a low power state; and control, by the Kubernetes agent, whether the one or more cores of the processor allocated to the Kubernetes agent are placed into a low power state based on a determination of whether the one or more cores of the processor allocated to the Kubernetes agent should be placed into a low power state.

Example 103 includes the subject matter of Example 102, and wherein to determine, by the Kubernetes agent, whether the one or more cores of the processor allocated to the Kubernetes agent should be placed into a low power state comprises to determining, by the Kubernetes agent, whether a user-defined threshold of pods is deployed to the one or more cores of the processor allocated to the Kubernetes agent.

Example 104 includes the subject matter of any of Examples 102 and 103, and wherein to determine, by the Kubernetes agent, whether the one or more cores of the processor allocated to the Kubernetes agent should be placed into a low power state comprises to determining, by the Kubernetes agent, whether a pod on a user-defined list of named pods is deployed to the one or more cores of the processor allocated to the Kubernetes agent.

Example 105 includes the subject matter of any of Examples 102-104, and wherein to determine, by the Kubernetes agent, whether the one or more cores of the processor allocated to the Kubernetes agent should be placed into a low power state comprises to determine, by the Kubernetes agent, whether the one or more cores of the processor allocated to the Kubernetes agent are not allocated to pods by the Kubernetes agent.

1. A orchestrator node comprising:
a processor;
a memory; and
one or more computer-readable media comprising a plurality of instructions stored thereon that, when executed by the orchestrator node, cause the orchestrator node to:
receive power telemetry data indicative of power usage data for a compute node;
analyze the power telemetry data, wherein to analyze the power telemetry data comprises to use rules to identify one or more processors and/or one or more processor cores as idle or unallocated;
apply one or more automation rules to the power telemetry data to determine one or more power state changes for the compute node; and
instruct the compute node to implement the one or more power state changes.

2. The orchestrator node of claim 1, wherein the plurality of instructions further cause the orchestrator node to apply one or more filters to the power telemetry data to identify one or more pre-defined metrics, wherein to analyze the power telemetry data comprises to analyze the one or more pre-defined metrics.

3. The orchestrator node of claim 1, wherein the power telemetry data includes a frequency of a processor of the compute node, a temperature of a processor of the compute node, a power state residency of the compute node, and processor core busy cycles of a processor of the compute node.

4. The orchestrator node of claim 3, wherein the power telemetry data includes a maximum thermal design power available for a processor package of the compute node, a current power consumption of a processor package of the compute node, and a current power consumption of a processor package memory subsystem.

5. The orchestrator node of claim 1, wherein to analyze the power telemetry data comprises to identify one or more isolated processors and/or processor cores that are not utilized as stranded processors and/or stranded processor cores.

6. The orchestrator node of claim 1, wherein to analyze the power telemetry data comprises to identify one or more non-isolated processors and/or processor cores that are rarely utilized as zombie processors and/or zombie processor cores.

7. The orchestrator node of claim 1, wherein the plurality of instructions further cause the orchestrator node to mark one or more processors and/or processor cores of the compute node as at least partially available in a scheduler in response to analysis of the power telemetry data.

8. The orchestrator node of claim 1, wherein the one or more automation rules consider average utilization of a processor or processor core over a period of time and maximum utilization of a processor or processor core over a period of time.

9. A system comprising the orchestrator node of claim 1, further comprising the compute node, the compute node comprising:
a processor;
a memory; and
one or more computer-readable media comprising a second plurality of instructions stored thereon that, when executed by the compute node, cause the compute node to:
allocate a plurality of cores of the processor to an orchestrator, wherein the orchestrator is configured to statically allocate cores of the plurality of cores to workloads deployed to the compute node;
receive one or more workloads;
statically allocate individual cores of the plurality of cores to the one or more workloads; and
place unallocated cores of the plurality of cores in a low-power mode.

10. A compute node comprising:
a processor;
a memory; and
one or more computer-readable media comprising a plurality of instructions stored thereon that, when executed by the compute node, cause the compute node to:
analyze one or more compute nodes of a data center;
determine whether one or more processor cores of one or more processors of the one or more compute nodes of the data center should be placed into a low-power mode based on analysis of the one or more compute nodes; and
place the one or more processor cores of the one or more processors of the one or more compute nodes into the low-power mode in response to a determination that the one or more processor cores of the one or more processors of the one or more compute nodes should be placed into the low-power mode.

11. The compute node of claim 10, wherein the plurality of instructions further cause the compute node to:
allocate a plurality of cores of a processor of the compute node to an orchestrator, wherein the orchestrator is configured to statically allocate cores of the plurality of cores to workloads deployed to the compute node;
receive one or more workloads;
statically allocate individual cores of the plurality of cores to the one or more workloads; and
place unallocated cores of the plurality of cores in a low-power mode.

12. The compute node of claim 11, wherein a cpuManagerPolicy setting of a Kubelet of a Kubernetes orchestrator is configured to static.

13. The compute node of claim 11, wherein the plurality of instructions further cause the compute node to:
monitor for a removal of a workload from the compute node; and
place an unallocated core corresponding to the workload in a low-power mode in response to removal of the workload.

14. The compute node of claim 11, wherein the plurality of instructions further cause the compute node to:
query a processor manager state file associated with the orchestrator, wherein the processor manage state file indicates workloads statically deployed to cores of the plurality of cores;
determine unallocated cores of the plurality of cores based on the processor manage state file; and
place the unallocated cores of the plurality of cores in a low-power state.

15. The compute node of claim 11, wherein the plurality of instructions further cause the compute node to:
perform an API query to an orchestrator component;
determine unallocated cores of the plurality of cores based on the API query; and
place the unallocated cores of the plurality of cores in a low-power state.

16. The compute node of claim 10, wherein the plurality of instructions further cause the compute node to:
allocate a plurality of cores of a processor of the compute node to an orchestrator, wherein the orchestrator is configured to not statically allocate cores of the plurality of cores to workloads deployed to the compute node;
determine a number of workloads deployed to the processor and/or an indication of whether workloads deployed to the processor should be deployed to cores in a specified power state; and
place cores of the plurality of cores in a power state based on the determination of a number of workloads deployed to the processor and/or an indication of whether workloads deployed to the processor should be deployed to cores in a specified power state.

17. The compute node of claim 16, wherein a cpuManagerPolicy setting of a Kubelet of a Kubernetes orchestrator is configured to none.

18. A compute node comprising:
a processor;
a memory; and
one or more computer-readable media comprising a plurality of instructions stored thereon that, when executed by the compute node, cause the compute node to:
allocate one or more cores of the processor to a Kubernetes agent;
determine, by the Kubernetes agent, whether the one or more cores of the processor allocated to the Kubernetes agent should be placed into a low power state; and
control, by the Kubernetes agent, whether the one or more cores of the processor allocated to the Kubernetes agent are placed into a low power state based on a determination of whether the one or more cores of the processor allocated to the Kubernetes agent should be placed into a low power state.

19. The compute node of claim 18, wherein to determine, by the Kubernetes agent, whether the one or more cores of the processor allocated to the Kubernetes agent should be placed into a low power state comprises to:
determine, by the Kubernetes agent, whether a user-defined threshold of pods is deployed to the one or more cores of the processor allocated to the Kubernetes agent.

20. The compute node of claim 18, wherein to determine, by the Kubernetes agent, whether the one or more cores of the processor allocated to the Kubernetes agent should be placed into a low power state comprises to:
determine, by the Kubernetes agent, whether the one or more cores of the processor allocated to the Kubernetes agent are not allocated to pods by the Kubernetes agent.
